(19) United States
(12) Patent Application Publication
(10) Pub. No.: US 2013/0048207 A1
(43) Pub. Date: Feb. 28, 2013

(54) CREATIVE TAPE MASKING SYSTEMS AND METHODS

(71) Applicant: Charlene Green, Northampton, PA (US)

(72) Inventor: Charlene Green, Northampton, PA (US)

(21) Appl. No.: 13/216,734

(22) Filed: Aug. 24, 2011

(51) Int. Cl. C09J 7/04; B32B 38/10

(52) U.S. Cl. 156/247; 428/343

(57) ABSTRACT

A creative tape masking system comprising: pressure sensitive tape made of thin, easy-to-tear paper and a cylinder. Creative tape masking system provides an aesthetically appealing design for wall surfaces when painted after pressure sensitive tape is removed. Creative tape masking system has a wavy design, which can be used to separate different colors on a vertical wall surface. Instead of the conventional straight line, creative tape masking system permits a user to create a squiggly line with one or more paint colors. The creative tape masking system includes a roll of blue painter's tape that measures approximately 60 yards long. The creative tape masking system is available in a variety of widths, such as 1″ to 3″ and is adhered to s vertical surface or horizontal surface(s) just as conventional painter's tape may be applied.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of masking tape and more specifically relates to uniquely patterned masking tape and methods of masking using such tape.

2. Description of the Related Art

Individuals in modern society often live in residences that they choose to decorate in an attempt to personalize the décor. Wallpapers may be used to cover walls; however wallpapers may be difficult to install and uninstall. Further, wallpapers may become quickly ‘dated’ and no-longer desirable. Often walls are covered in paint to protect the underlying surfaces and to provide the desired aesthetic appeal. These paints may come in various colors and finishes that the occupants may select from according to their personal taste(s). However, consumers are always looking for new ways to decorate a room and may feel a sense of ‘something missing’ since the paint products are normally applied in a standard method whereby straight lines are achieved.

Parents, as homeowners or renters often want a fun and unique style to decorate their kids' rooms. When painting, tape is often used as a masking means to keep colors from bleeding into one another or covering the adjacent section(s) that may be in a different color or texture. Conventional painter's masking tape may be currently only available in a straight-rolled design and does not allow for wavy or other similarly shaped lines. To form wavy or other similarly contoured lines may take a very long time and great deal of effort being expended to achieve such results.

Various attempts have been made to solve the above-mentioned problems such as those found in U.S. Pat. And Pub. Nos. 2005/0045265; 2006/0123650; 2006/0099412; 2008/0020181; 6,779,443; and 4,129,669. This prior art is representative of masking tape and taping means. None of the above inventions and patents, taken either singly or in combination, is seen to describe the invention as claimed.

Ideally, a masking tape should be user-friendly to install, allow the user to create uniquely designed patterns to enhance aesthetic appeal in interior and exterior applications and, yet would operate reliably and be manufactured at a modest expense. Thus, a need exists for a reliable creative tape masking system(s) and method(s) to avoid the above-mentioned problems.

### BRIEF SUMMARY OF THE INVENTION

In view of the foregoing disadvantages inherent in the known masking art, the present invention provides a novel masking system. The general purpose of the present invention, which will be described subsequently in greater detail is to provide an aesthetically appealing design for wall surfaces when painted after the novel masking is removed.

The present creative tape masking systems as disclosed herein preferably comprises: a pressure sensitive tape made of thin, easy-to-tear paper and a cylinder. The easy-to-tear paper is rolled sequentially about the cylinder. The paper comprises a top side and a bottom side and a first outer edge and a second outer edge. The top side and the bottom side are disposed opposed to each other and comprise the easy-to-tear paper. The first outer edge and the second outer edge of the pressure sensitive tape do not comprise a continuous straight-edge along their respective lengths. The first and second outer edge of the pressure sensitive tape form a repeating wave-shaped-profile. The repeating wave-shaped-profile comprises crests and troughs and includes substantially equal wavelengths (or unequal in other embodiments.) The first outer edge and the second outer edge run offset and parallel to each other along the respective lengths.

The cylinder matches the repeating wave-shaped-profile of the pressure sensitive tape such that the pressure sensitive tape comprises a suitably structural backing when rolled thereon and therefrom. The pressure sensitive tape is appliable with pressure to the vertical (wall)) surface (or the horizontal surface(s)—ledges or other) and the appliable covering materials (paint, stipple or other product that is rolled, brushed or the like) is applied, then the pressure sensitive tape is removed to reveal a repeating geometric pattern on the vertical surface or the horizontal surface(s). The repeating wave-shaped-profile comprises a sinusoidal wave, a squiggle, a square wave, a triangular wave, or a saw-tooth wave (other shapes may be used.) The repeating wave-shaped-profile may comprise different widths and increments between the designs/patterns.

The bottom side preferably comprises at least one pressure sensitive adhesive which forms a bond when sufficient pressure is applied to marry the pressure sensitive adhesive with an adherend. The adherend comprises a vertical surface or horizontal surface (wall surface.) Further, the pressure sensitive tape is sequentially unrollable from the cylinder and is used to mask the adherend to create a separation between disparate covering materials and/or prevent the covering materials from contacting certain portions of the vertical surface or the horizontal surface(s). The pressure sensitive tape is removable from the adherend after a time duration has elapsed (after paint has suitably dried) whereby the separation between the disparate covering materials and/or the portions of the vertical surface or the horizontal surface(s) is no longer needed, the pressure sensitive tape being removable without leaving residue of the pressure sensitive adhesive on the vertical surface or the horizontal surface.

The pressure sensitive adhesive of the pressure sensitive tape when the pressure is applied forms a temporary bond to the vertical surface or the horizontal surface(s) that may be repeatedly stuck and unstuck by being pushed on pulled onto or from a surface. The pressure sensitive adhesive and the adherend when in proximity have molecular interactions; the molecular interactions defined by Van Der Waals forces. A degree of the bond of the pressure sensitive adhesive is influenced by an amount of pressure which is used to apply the pressure sensitive adhesive to the vertical surface or the horizontal surface(s).

The pressure sensitive adhesive may be made from liquid PSAs which are coated on the easy-to-tear paper before being rolled (sequentially about) onto the cylinder. The PSAs are preferably based on an elastomer compounded with a suitable tackifier. The pressure sensitive tape is available in several strengths, rated on a 1-100 scale based on a relative strength of the pressure sensitive adhesive. The pressure sensitive adhesive is characterized by its shear holding. The shear holding characterizes the pressure sensitive adhesive's ability to hold (in a shear mode) which is related to (determined by) a formulation, a coating thickness, a rub-down, and a temperature.

A kit is embodied herein for the creative tape masking system comprising: rolls of the pressure sensitive tape with the rolls comprising different widths and or repeating wave-shaped-profiles; and a set of user instructions for creating the aesthetically appealing design(s).

In accordance with the embodiments of the present invention a preferred method of use is disclosed herein comprising: unrolling a pressure sensitive tape from a cylinder; masking a surface; covering the surface with a surface covering (paint or the like); waiting for the surface covering to dry (partially or fully); removing the pressure sensitive tape thereby creating a design with the design comprises a wave form such as a sinusoidal wave, a square wave, a triangular wave, and/or a sawtooth wave; and optionally applying the pressure sensitive tape wherein the wave form comprises different widths (to form a different design.)

The present invention holds significant improvements and serves as a creative tape masking systems and methods. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, creative tape masking system, constructed and operative according to the teachings of the present invention.

FIG. 1 shows a perspective view illustrating pressure sensitive tape(s) of a creative tape masking system according to an embodiment of the present invention.

FIG. 2 is a perspective view illustrating an unrolling and applying application of the pressure sensitive tape to a vertical surface such as a wall according to an embodiment of the present invention of FIG. 1.

FIG. 3 is a perspective view illustrating an as-applied condition of the pressure sensitive tape on the wall with a covering (paint) applied over the pressure sensitive tape (as masking) and the wall according to an embodiment of the present invention of FIGS. 1 and 2.

FIG. 4 is a perspective view illustrating the wall when masking (the pressure sensitive tape) is removed leaving a design wherein the design may take different forms if different sized masking as used according to an embodiment of the present invention of FIGS. 1-3.

FIG. 5 is a flowchart illustrating a method of using the creative tape masking system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a masking tape and more particularly to a masking system as used to improve the aesthetic appearance of interior and/or exterior walls of residential and commercial buildings.

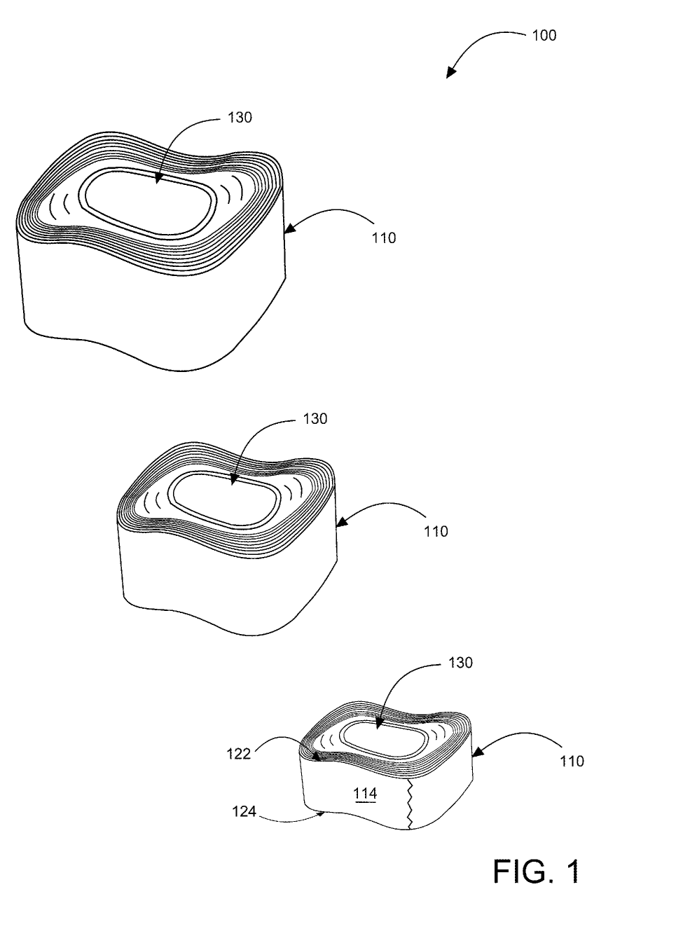

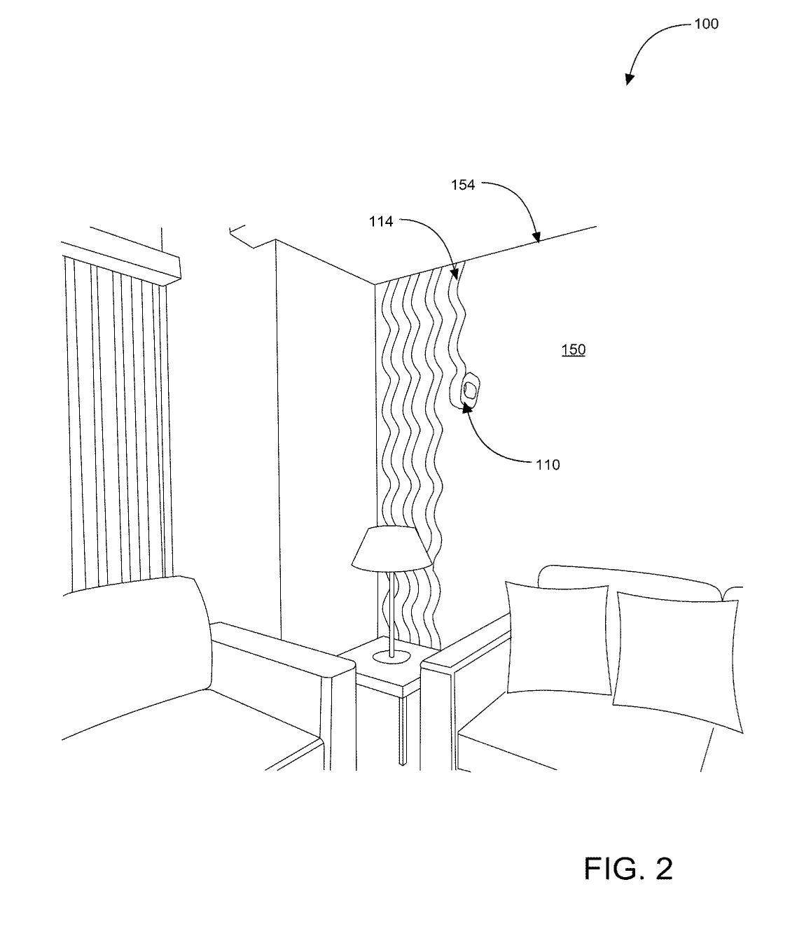

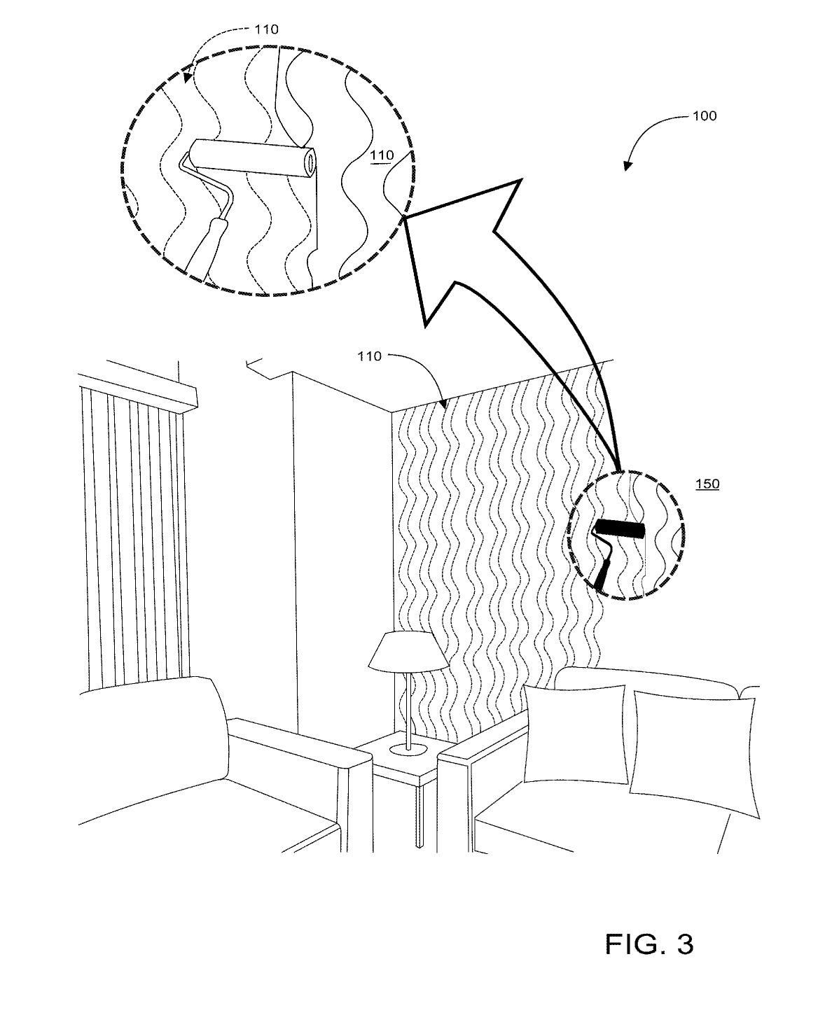

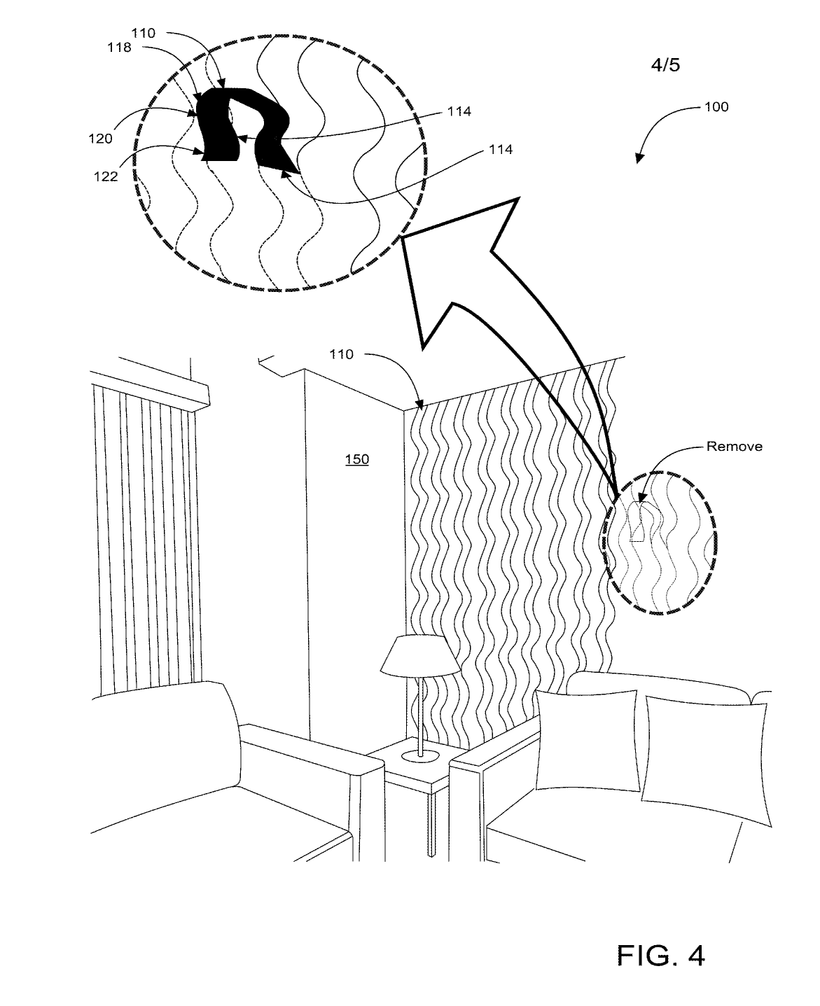

Referring now to the drawings by specific numerals of reference there is shown in FIGS. 1-4, various views of pressure sensitive tape 102 of creative tape masking system 100 including in FIG. 1, a perspective view illustrating pressure sensitive tape 102 of creative tape masking system 100, in FIG. 2 a perspective view illustrating an unrolling and applying application of pressure sensitive tape 102 to vertical surface 150 such as a wall, in FIG. 3 an as-applied condition of pressure sensitive tape 102 on the wall with a covering applied over pressure sensitive tape 102 (as masking) and the wall, and in FIG. 4 a perspective view illustrating the wall when the masking (pressure sensitive tape 102) is removed leaving a design wherein the design may take different forms if different sized masking is used according to an embodiment of the present invention of FIGS. 1-3.

Referring now to FIGS. 1-4, illustrating creative tape masking system 100 according to embodiments of the present invention. Generally speaking, creative tape masking system 100 allows a user to create wavy designs on vertical surface 150 such as walls (as shown best in FIG. 2) or horizontal surface(s) 154. Creative tape masking system 100 preferably includes a roll of blue painter's tape that measures approximately 60 yards long as shown in FIG. 1. Creative tape masking system 100 preferably has a wavy design on the top and bottom edges of the roll as alluded to in FIG. 2. Creative tape masking system 100 may be available in a variety of widths, such as 1″ to 3″ as shown in FIG. 1. Creative tape masking system 100 may be adhered to vertical surface 150 or horizontal surface(s) 154 in a similar manner to how conventional painter's tape is (pressure) applied. Once the wall has been painted, creative tape masking system 100 may be removed, leaving a ‘squiggly’ design in its place.

Creative tape masking system 100 preferably comprises: pressure sensitive tape 110 made of thin, easy-to-tear paper and cylinder 130 as shown in FIG. 1. Creative tape masking system 100 preferably provides an aesthetically appealing design for wall surfaces when painted after pressure sensitive tape 110 is removed. Creative tape masking system 100 offers the user a unique alternative to traditional painter's tape. Creative tape masking system 100 has a wavy design, which can be used to separate different colors on vertical surface 150. Instead of the conventional straight line, creative tape masking system 100 may permit user 180 to create a squiggly line with one or more paint colors as shown in FIG. 3. Creative tape masking system 100 can be used in kids' rooms or virtually any other room to add a unique and creative look to painted surfaces.

The easy-to-tear paper (pressure sensitive tape 110 as made of paper) is rolled sequentially about cylinder 130 as shown in FIG. 1. The easy-to-tear paper comprises top side 114 and a bottom side 118 and a first outer edge 122 and second outer edge 124. Top side 114 and bottom side 118 are preferably disposed opposed to each other and comprise the easy-to-tear paper. First outer edge 122 and second outer edge 124 of pressure sensitive tape 110 do not comprise a continuous straight-edge along their respective lengths. First outer edge 122 and second outer edge 124 of the pressure sensitive tape 110 may form a repeating wave-shaped-profile as shown in FIG. 2. The repeating wave-shaped-profile comprises crests and troughs and may preferably be equal wavelengths. First outer edge 122 and second outer edge 124 of the pressure sensitive tape 110 may preferably run offset and parallel to each other along the respective lengths (such that the width is uniform throughout the roll.)

Cylinder 130 preferably matches the repeating wave-shaped-profile (outer shape) of pressure sensitive tape 110 such that pressure sensitive tape 110 comprises a suitably structural backing when rolled thereon and therefrom. Pressure sensitive tape 110 is applied with pressure (by pushing) to vertical surface 150 or horizontal surface(s) 154 and the appliable covering materials is then applied, then pressure sensitive tape 110 is removed to reveal a repeating geometric pattern on vertical surface 150 or the horizontal surface(s) 154 as shown in FIG. 4. The repeating wave-shaped-profile may comprise but is not limited to a sinusoidal wave, squiggles, a square wave, a triangular wave, or a saw-tooth wave. Further, the repeating wave-shaped-profile may comprise different widths, as previously mentioned.

Bottom side 118 of pressure sensitive tape 110 preferably comprises at least one pressure sensitive adhesive 120 which forms at least one bond when sufficient pressure is applied to marry pressure sensitive adhesive 120 with at least one adherend. The adherend comprises vertical surface 150 or horizontal surface(s) 154. Further, the pressure sensitive tape 110 is sequentially unrollable from cylinder 130 (as masking procedure progresses) and is used to mask the adherend to create a separation between disparate covering materials (paint of different colors, textures or other) and/or prevent the covering materials from contacting certain portions of vertical surface 150 or horizontal surface(s) 154. Pressure sensitive tape 110 is preferably removable from the adherend after a time duration has elapsed whereby the separation between the disparate covering materials and/or the portions of the vertical surface 150 or horizontal surface(s) 154 is no longer needed; pressure sensitive tape 110 being removable without leaving residue of pressure sensitive adhesive 120 on vertical surface 150 or horizontal surface(s) 154 as shown in FIG. 4.

Pressure sensitive adhesive 120 of pressure sensitive tape 110, when the pressure is applied, forms a temporary bond to vertical surface 150 or horizontal surface(s) 154 that may be repeatedly stuck and unstuck therefrom as shown in FIGS. 2 & 3. Pressure sensitive adhesive 120 and the adherend when in proximity have molecular interactions; the molecular interactions defined by Van Der Waals forces. Van Der Waals forces are defined as the sum of the attractive or repulsive forces between molecules (or between parts of the same molecule) other than those due to covalent bonds or to the electrostatic interaction of ions with one another or with neutral molecules. A degree of the bond of pressure sensitive adhesive 120 is influenced by an amount of pressure which is used to apply pressure sensitive adhesive 120 to vertical surface 150 or horizontal surface(s) 154. Pressure sensitive tape 110 is preferably removable (unbonded without destroying the finish of the surface it is covering) from the adherend after a time duration has elapsed whereby the separation between the disparate appliable covering materials and/or the portions of vertical surface 150 or horizontal surface(s) 154 is no longer needed, pressure sensitive tape 110 being removable without leaving residue of the pressure sensitive adhesive 120 on vertical surface 150 or horizontal surface(s) 154 as shown in FIG. 4.

Pressure sensitive adhesive 120 may be made from liquid PSAs which is coated on the easy-to-tear paper before being rolled on cylinder 130. The PSAs may be based on an elastomer compounded with a suitable tackifier. Pressure sensitive tape 110 is available in several strengths, rated on a 1-100 scale based on a relative strength of the pressure sensitive adhesive 120. Pressure sensitive adhesive 120 is characterized by its shear holding. The shear holding characterizes the adhesive ability of pressure sensitive adhesive 120 to hold in a shear mode which is related to a formulation (determined by manufacturer), a coating thickness, a rub-down, and a temperature (determined by installer-user.) Those with ordinary skill in the art will now appreciate that upon reading this specification and by their understanding the art of adhesives, their manufacture, their formulations, testing, and use as described herein, methods of making and using such adhesives will be understood by those knowledgeable in such art.

Creative tape masking system 100 may be sold as kit 440 comprising rolls of the pressure sensitive tape 110 with the rolls of the pressure sensitive tape 110 comprising different widths and or repeating wave-shaped-profiles; and a set of user instructions for creating the aesthetically appealing design(s). Creative tape masking system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, may include other painting/covering accessories, parts may be sold separately, etc., may be sufficient.

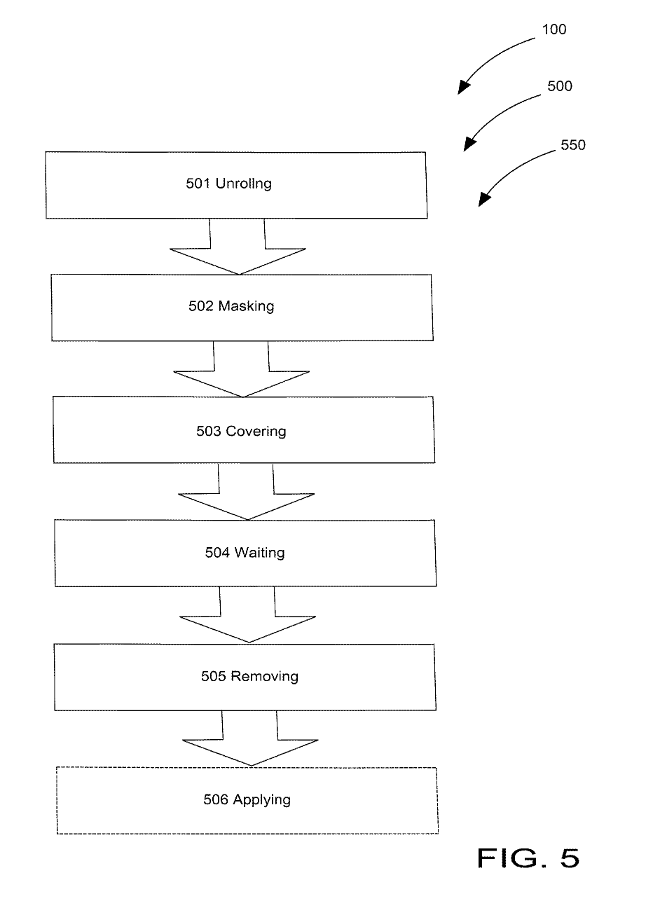

FIG. 5. shows a flowchart 550 illustrating a method of use 500 according to an embodiment of the present invention of FIGS. 1-4.

Referring now to FIG. 5. showing a method (at least herein embodying method of use 500) of using creative tape masking system 100 preferably comprises the steps of: step one 501 unrolling pressure sensitive tape 110 from cylinder 130; step two 502 masking a surface; step three 503 covering (painting or other) the surface with a surface covering; step four 504 waiting for the surface covering to dry (fully or partially); step five 505 removing pressure sensitive tape 110 thereby creating a design with the design comprises a wave form such as a sinusoidal wave, a square wave, a triangular wave, and/or a sawtooth wave; and step six 506 optionally applying pressure sensitive tape 110 wherein the wave form comprises different widths (to create different designs.)

It should be noted that step 506 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A creative tape masking system comprising:
a pressure sensitive tape made of thin, easy-to-tear paper;
a cylinder;
wherein said easy-to-tear paper is rolled sequentially about said cylinder;
wherein said easy-to-tear paper comprises a top side and a bottom side and a first outer edge and a second outer edge;
wherein said top side and said bottom side are disposed opposed to each other and comprise said easy-to-tear paper;
wherein said bottom side comprises at least one pressure sensitive adhesive which forms at least one bond when sufficient pressure is applied to many said pressure sensitive adhesive with at least one adherend;
wherein said adherend comprises a vertical surface or horizontal surface;
wherein said pressure sensitive tape is sequentially unrollable from said cylinder and is used to mask said adherend to create a separation between disparate appliable covering materials and/or prevent said appliable covering materials from contacting certain portions of said vertical surface or said horizontal surface(s);
wherein said pressure sensitive tape is removable from said adherend after a time duration has elapsed whereby said separation between said disparate appliable covering materials and/or said portions of said vertical surface or said horizontal surface(s) is no longer needed, said pressure sensitive tape being removable without leaving residue of said pressure sensitive adhesive on said vertical surface or said horizontal surface;
wherein said first outer edge and said second outer edge of said pressure sensitive tape do not comprise a continuous straight-edge along their respective lengths;
wherein said first outer edge and said second outer edge of said pressure sensitive tape form a repeating wave-shaped-profile;
wherein said repeating wave-shaped-profile comprises crests and troughs;
wherein said repeating wave-shaped-profile comprises equal wavelengths;
wherein said first outer edge and said second outer edge of said pressure sensitive tape run offset and parallel to each other along their said respective lengths;
wherein said cylinder matches said repeating wave-shaped-profile of said pressure sensitive tape such that said pressure sensitive tape comprises a suitably structural backing when rolled thereon and therefrom; and
wherein said pressure sensitive tape is applied with pressure to said vertical surface or said horizontal surface(s) and said appliable covering materials is applied, then said pressure sensitive tape is removed to reveal a repeating geometric pattern on said vertical surface or said horizontal surface(s).

2. The creative tape masking system of claim 1 wherein said pressure sensitive adhesive of said pressure sensitive tape, when said pressure is applied, forms a temporary said bond to said vertical surface or said horizontal surface(s) that may be repeatedly stuck and unstuck.

3. The creative tape masking system of claim 1 wherein said pressure sensitive adhesive and said adherend when in proximity have molecular interactions, said molecular interactions defined by Van Der Waals forces.

4. The creative tape masking system of claim 1 wherein a degree of said bond of said pressure sensitive adhesive is influenced by an amount of said pressure which is used to apply the pressure sensitive adhesive to said vertical surface or said horizontal surface(s).

5. The creative tape masking system of claim 1 wherein said pressure sensitive adhesive is made from liquid PSAs which is coated on said easy-to-tear paper before being rolled on said cylinder.

6. The creative tape masking system of claim 5 wherein said PSAs are based on an elastomer compounded with a suitable tackifier.

7. The creative tape masking system of claim 1 wherein said pressure sensitive tape is available in several strengths, rated on a 1-100 scale based on a relative strength of the pressure sensitive adhesive.

8. The creative tape masking system of claim 1 wherein said repeating wave-shaped-profile comprises a sinusoidal wave

9. The creative tape masking system of claim 1 wherein said repeating wave-shaped-profile comprises a square wave.

10. The creative tape masking system of claim 1 wherein said repeating wave-shaped-profile comprises a triangular wave.

11. The creative tape masking system of claim 1 wherein said repeating wave-shaped-profile comprises a sawtooth wave.

12. The creative tape masking system of claim 1 wherein said repeating wave-shaped-profile comprises different widths.

13. The creative tape masking system of claim 7 wherein said pressure sensitive adhesive is characterized by its shear holding.

14. The creative tape masking system of claim 13 wherein said shear holding characterizes said pressure sensitive adhesive's ability to hold in a shear mode which is related to a formulation, a coating thickness, a rub-down, and a temperature.

15. A creative tape masking system comprising:
a pressure sensitive tape made of thin, easy-to-tear paper;
a cylinder;
wherein said easy-to-tear paper is rolled sequentially about said cylinder;
wherein said easy-to-tear paper comprises a top side and a bottom side and a first outer edge and a second outer edge;
wherein said top side and said bottom side are disposed opposed to each other and comprise said easy-to-tear paper;
wherein said bottom side comprises at least one pressure sensitive adhesive which forms at least one bond when sufficient pressure is applied to many said pressure sensitive adhesive with at least one adherend;
wherein said adherend comprises a vertical surface or horizontal surface;
wherein said pressure sensitive tape is sequentially unrollable from said cylinder and is used to mask said adherend to create a separation between disparate covering materials and/or prevent said covering materials from contacting certain portions of said vertical surface or said horizontal surface(s);
wherein said pressure sensitive tape is removable from said adherend after a time duration has elapsed whereby said separation between said disparate covering materials and/or said portions of said vertical surface or said horizontal surface(s) is no longer needed, said pressure sensitive tape being removable without leaving residue of said pressure sensitive adhesive on said vertical surface or said horizontal surface;
wherein said first outer edge and said second outer edge of said pressure sensitive tape do not comprise a continuous straight-edge along their respective lengths;
wherein said first outer edge and said second outer edge of said pressure sensitive tape form a repeating wave-shaped-profile;
wherein said repeating wave-shaped-profile comprises crests and troughs;
wherein said repeating wave-shaped-profile comprises a sequence of equal wavelengths;
wherein said first outer edge and said second outer edge of said pressure sensitive tape run offset and parallel to each other along said respective lengths, a width remaining uniform;
wherein said cylinder matches said repeating wave-shaped-profile of said pressure sensitive tape such that said pressure sensitive tape comprises a suitably structural backing when said pressure sensitive tape is rolled thereon and therefrom;
wherein said pressure sensitive adhesive of said pressure sensitive tape when said pressure is applied forms a temporary said bond to said vertical surface or said horizontal surface(s) that may be repeatedly stuck and unstuck;
wherein said pressure sensitive adhesive and said adherend when in proximity have molecular interactions, said molecular interactions governed by Van Der Waals forces;
wherein a degree of said bond of said pressure sensitive adhesive is influenced by an amount of said pressure which is used to apply the pressure sensitive adhesive to said vertical surface or said horizontal surface(s);
wherein said pressure sensitive adhesive is made from liquid PSAs which is coated on said easy-to-tear paper before being rolled on said cylinder;
wherein said PSAs are based on an elastomer compounded with a tackifier;
wherein said pressure sensitive tape is available in several strengths, rated on a 1-100 scale based on a relative strength of the pressure sensitive adhesive;
wherein said repeating wave-shaped-profile comprises a sinusoidal wave;
wherein said pressure sensitive adhesive is characterized by its shear holding;
wherein said shear holding characterizes said pressure sensitive adhesive's ability to hold in a shear mode which is related to a formulation, a coating thickness, a rub-down, and a temperature; and
wherein said pressure sensitive tape is applied with said pressure to said vertical surface or said horizontal surface(s) and said covering materials are applied, then said pressure sensitive tape is removed to reveal a repeating geometric pattern on said vertical surface or said horizontal surface(s) creating at least one aesthetically appealing design.

16. The creative tape masking system of claim 15 further comprising a kit including:
rolls of said pressure sensitive tape;
wherein said rolls may comprise different widths and or said repeating wave-shaped-profiles; and
a set of user instructions for creating said aesthetically appealing design(s).

17. A method of using a creative tape masking system comprising the steps of:
unrolling a pressure sensitive tape from a cylinder;
masking a surface;
covering said surface with a surface covering;
waiting for said surface covering to dry;
removing said pressure sensitive tape thereby creating a design; and
wherein said design comprises a wave form.

18. The method of claim 17 wherein said wave form comprises a sinusoidal wave, a square wave, a triangular wave, and/or a sawtooth wave.

19. The method of claim 17 wherein said wave form comprises a squiggly line.

20. The method of claim 17 further comprising the step of applying said pressure sensitive tape wherein said wave form comprises different widths.
